(19) United States
(12) Patent Application Publication
(10) Pub. No.: US 2010/0198703 A1
(43) Pub. Date: Aug. 5, 2010

(54) SYSTEMS AND METHODS FOR SHARING TANGIBLE ITEMS

(75) Inventor: Richard Pickering, Suwanee, GA (US)

Correspondence Address: KASHA LAW LLC, 14532 Dufief Mill Road, North Potomac, MD, 20878, US

(73) Assignee: NATIONAL BOOK SWAP, LLC

(21) Appl. No.: 12/758,748

(22) Filed: Apr. 12, 2010

Related U.S. Application Data
(63) Continuation-in-part of application No. 11/230,910, filed on Sep. 20, 2005.
(60) Provisional application No. 61/168,358, filed on Apr. 10, 2009.

(51) Int. Cl. G06Q 30/00; G06Q 50/00; G06Q 99/00; G06F 17/30

(52) U.S. Cl. 705/27; 705/319; 707/769; 707/E17.014

(57) ABSTRACT

A request list for two or more tangible items is received by a server from a first user through the Internet connection. A request for a bulk shipment of a minimum number of tangible items from the request list is received from the first user to begin a transaction through the Internet connection. The request list is searched for minimum number of tangible items producing a selected list of tangible items. The electronic database is searched for a second user willing to exchange the selected list of tangible items. A first message is sent to the second user through the Internet connection requesting that the second user ship the selected list of tangible items to the first user. A second message is received from the first user through the Internet connection that the selected list of tangible items is received by the first user completing the transaction.

### CROSS-REFERENCE TO RELATED APPLICATION

This application is a continuation-in-part application of U.S. patent application Ser. No. 11/230,910, filed Sep. 20, 2005. This application also claims the benefit of U.S. Provisional Patent Application No. 61/168,358, filed Apr. 10, 2009.

### BACKGROUND OF THE INVENTION

1. Field of the Invention

Embodiments of the present invention relate to systems and methods for managing the sharing tangible items among users in an online system. More particularly, embodiments of the present invention relate to systems and methods for managing the availability of tangible items and sharing of tangible items in an online system.

2. Background Information

An online system that manages the sharing or swapping of tangible items is described, for example, in U.S. patent application Ser. No. 11/230,910 (hereinafter the “'910 application”), which is herein incorporated by reference in its entirety. A system of the '910 application allows users to obtain credits for tangible items that they ship to other users. These credits are then, in turn, used to receive tangible items from the other users. Through the use of credits, the system of the '910 application effectively manages the sharing of tangible items among three or more users. In a swapping system, such as the system of the '910 application, the number of tangible items available to users of the system is generally dependent on the number of tangible items offered for swapping by the users of the system.

In view of the foregoing, it can be appreciated that a substantial need exists for systems and methods that can increase the availability of tangible items in an online system for managing the sharing of tangible items among users.

### BRIEF DESCRIPTION OF THE DRAWINGS

FIG. 1 is a schematic diagram showing a system for managing the sharing of tangible items among users and increasing the availability of tangible items to users, in accordance with various embodiments.

FIG. 2 is a time diagram showing the sharing of tangible items in a group purchase transaction over time, in accordance with various embodiments.

FIG. 3 is a time diagram showing the sharing of tangible items among the first members of four overlapping groups participating in a group purchase transaction with overlapping groups over time, in accordance with various embodiments.

FIG. 4 is a time diagram showing the sharing of tangible items among the second members of four overlapping groups participating in a group purchase transaction with overlapping groups over time, in accordance with various embodiments.

FIG. 5 is a time diagram showing the sharing of tangible items among the third members of four overlapping groups participating in a group purchase transaction with overlapping groups over time, in accordance with various embodiments.

FIG. 6 is a time diagram showing the sharing of tangible items among the fourth members of four overlapping groups participating in a group purchase transaction with overlapping groups over time, in accordance with various embodiments.

FIG. 7 is a flowchart showing a method for managing the exchange of tangible items using bulk shipping and a request list, in accordance with various embodiments.

FIG. 8 is a schematic diagram of a system of distinct software modules that performs a method for managing the exchange of tangible items using bulk shipping, in accordance with various embodiments.

FIG. 9 is a flowchart showing a method for managing the exchange of tangible items using bulk shipping, in accordance with various embodiments.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

Embodiments of systems and methods related to managing the availability of tangible items and sharing of tangible items in an online system are described in this detailed description of the invention. In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

In various embodiments, a tangible item can include, but is not limited to, a book, a compact disc (CD), a digital video disc (DVD), a flash memory, or any physical medium capable of including intellectual property content. Intellectual property content can include, but is not limited to, an audio recording, music, a video recording, a movie, a game, software, or a photograph. A tangible item can also include any item that a user can use for a short period of time and then swap with another user for an item of similar value, such as a collectable, toy, baby clothing, or child car seat, for example.

In various embodiments, an online system for managing the sharing of tangible items among users and increasing the availability of tangible items to users includes a web server, an electronic database, and an Internet connection. The web server is in communication with the electronic database and stores and retrieves information from the electronic database. The web server receives and sends information to users at web clients through the Internet connection.

In various embodiments, a method for managing the sharing of tangible items among users and increasing the availability of tangible items to users includes a system of distinct software modules embodied on a computer-readable medium. The distinct software modules of this system manage the addition or subtraction of tangible items available to users and the sharing of tangible items among users.

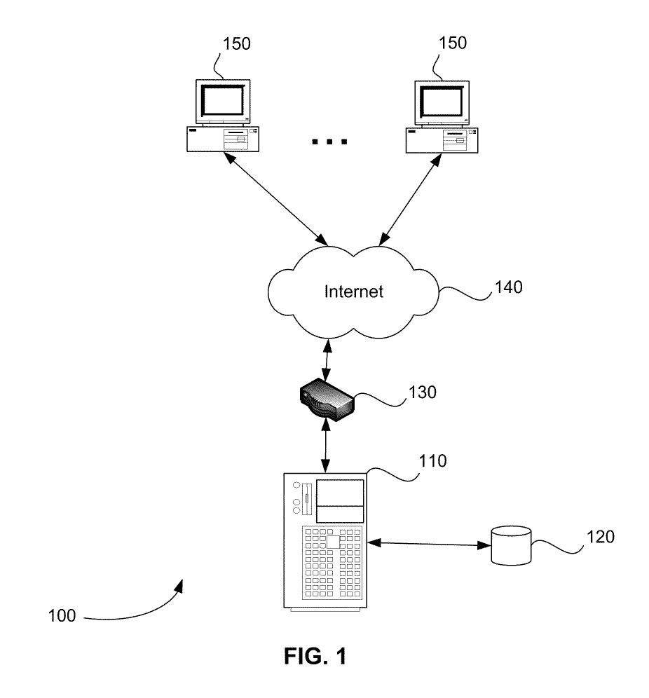

FIG. 1 is a schematic diagram showing a system 100 for managing the sharing of tangible items among users and increasing the availability of tangible items to users, in accordance with various embodiments. System 100 includes computer server 110, electronic database 120, and Internet connection 130. Server 110 sends information to and receives information from a plurality of users using a plurality of clients 150 connected to the Internet 140.

### Swapping Transaction

System 100 manages the sharing of tangible items among users by managing swapping transactions. A swapping transaction begins when server 110 receives a request through Internet connection 130 from a first user for a tangible item. Upon receiving the request, server 110 removes a first credit stored for the first user in electronic database 120. The first credit was, for example, stored by server 110 in electronic database 120 for the first user as part of a previous transaction.

Server 110 then sends a message to a second user through Internet connection 130 directing the second user to send the tangible item to the first user. The second user previously sent a message to server 110 through Internet connection 130 describing the availability of the tangible item and server 110 listed the tangible on its web site, and stored it as an available item from the second user in electronic database 120, for example.

Finally, server 110 receives a message through Internet connection 130 confirming that the tangible item was received by the first user and stores a second credit for the second user in electronic database 120 completing the swapping transaction. The message confirming that the tangible item was received can be from the first user or from a confirmation service from a shipping company or post office, for example. The second user can, in turn, use the second credit in another swapping transaction to request a tangible item from the first user or another user.

Server 110 can also receive a request through Internet connection 130 from a user for one or more tangible items not listed on the web site of server 110 or stored in electronic database 120 as available from any other user. Server 110 stores such one or more tangible items as a “wish list” for the user in electronic database 120.

In various embodiments, Server 110 can also list one on more tangible items on the web site of server 110 that are available to users, but are not listed by other members. These one or more tangible items are listed by system 100, for example. Server 110 can receive a request through Internet connection 130 from a user for one or more of these system listed tangible items. Server 110 stores such one or more server listed tangible items as a “request list” for the user in electronic database 120.

### Purchase Transaction

Server 110 can increase the availability of tangible items managed by system 100 by performing a purchase transaction. Server 110 begins a purchase transaction by examining a wish list or request list of a user in electronic database 120 and selecting one or more tangible items from the wish list or request list. In various embodiments and alternatively, a purchase transaction can begin by receiving a request for a tangible item from a user. Server 110 then sends a message to the user through Internet connection 130 offering to allow the user to purchase the one or more tangible items. Purchasing two or more tangible items can reduce shipping costs, for example.

The offer can be a purchase price in currency, a purchase price in credits, or a purchase price that is a combination of currency and credits, for example. In various embodiments, server 110 can search a plurality of wish list or request lists in electronic database 120 for tangible items common to multiple users and base the offered price based on a bulk purchase of a common tangible item. In various embodiments, server 110 can search electronic database 120 for users with large numbers of credits and base the offer on the number of credits a user has available. In various embodiments, server 110 can select users that are offered tangible items based on the tangible items on their wish lists or request lists, the number of credits stored for them, or a combination of both.

When server 110 receives a message from the user through Internet connection 130 accepting an offer to purchase the one or more tangible items, server 110 sends and receives payment information from the user through Internet connection 130. In various embodiments, the payment information includes credits or currency. Server 110 then processes the currency payment through a third party (e.g., credit card company) and/or removes one or more credits from the user in electronic database 120.

Server 110 sends a message to a seller of the one or more tangible items directing the seller to ship the one or more tangible items to the user. Server 110 receives a message through Internet connection 130 confirming that the user received the one or more tangible items completing the purchase transaction. The message confirming that the one or more tangible items were received can be from the user or from a confirmation service from a shipping company or post office.

### Peer-to-Peer Renting Transaction

In various embodiments, server 110 can increase the availability of tangible items managed by system 100 by performing a peer-to-peer renting transaction. Server 110 begins a peer-to-peer renting transaction by examining a wish list or request list of a user in electronic database 120 and selecting one or more tangible items from the wish list or request list. In various embodiments and alternatively, a peer-to-peer renting transaction can begin by receiving a request for a tangible item from a user. Server 110 then sends a message to the user through Internet connection 130 offering to allow the user to rent the one or more tangible items. Renting two or more tangible items can reduce shipping costs, for example.

The offer includes a period of time of the rental and a rental price. The rental price can be in currency, in credits, or a combination of currency and credits, for example. In various embodiments, server 110 can search a plurality of request list or wish lists or request lists in electronic database 120 for tangible items common to multiple users and base the rental price based on a bulk purchase of a common tangible item. In various embodiments, server 110 can search electronic database 120 for users with large numbers of credits and base the rental price on the number of credits a user has available. In various embodiments, server 110 can select users that are offered tangible items based on the tangible items on their wish lists or request lists, the number of credits stored for them, or a combination of both.

When server 110 receives a message from the user through Internet connection 130 accepting an offer to rent the one or more tangible items, server 110 sends and receives payment information from the user through Internet connection 130. In various embodiments, the payment information includes credits or currency. Server 110 then processes the currency payment through a third party (e.g., credit card company) and/or removes one or more credits from the user in electronic database 120.

Server 110 then sends a message to another user currently renting the one or more tangible items through Internet connection 130 directing the other user to send the tangible item to the first user. The message can include a pre-paid and addressed mailing label, for example. If this is the first time the one or more tangible items are added to system 100, server 110 sends a message to a seller of the one or more tangible items directing the seller to ship the one or more tangible items to the user.

Server 110 receives a message through Internet connection 130 confirming that the user received the one or more tangible items completing the peer-to-peer rental transaction. The message confirming that the one or more tangible items were received can be from the user or from a confirmation service from a shipping company or post office.

### Group Purchase Transaction

In various embodiments, server 110 can increase the availability of tangible items managed by system 100 by performing a group purchase transaction. Server 110 begins a group purchase transaction by examining the wish lists or request lists of two or more users in electronic database 120. Server 110 creates a group of two or more users that have two or more tangible items in common on their wish lists or request lists. Preferably, the number of tangible items that group members have in common is greater than or equal to the number of members in the group. Server 110 then sends a message to each of the two or more users in the group through Internet connection 130 offering to allow each user to purchase the use of the tangible items that group members have in common over a period of time. Each group member is able to use each tangible item at a different time interval within the period of time.

Each offer includes the period of time of the use and the price for joining the group. The price can be in currency, in credits, or a combination of currency and credits, for example. In various embodiments, server 110 can search electronic database 120 for users with large numbers of credits and base the price on the number of credits a user has available. In various embodiments, server 110 can select users that are offered to join the group based on the tangible items on their wish lists or request lists and the number of credits stored for them.

When server 110 receives a message from each member of the group through Internet connection 130 accepting the offer to join the group, server 110 sends and receives payment information to and from each user of the group through Internet connection 130. Server 110 then processes the currency payment through a third party (e.g., credit card company) and/or removes one or more credits from each user of the group in electronic database 120.

Server 110 sends a message to a seller of the tangible items that group members have in common directing the seller to ship at least one of the tangible items to each member of the group. Server 110 receives a message through Internet connection 130 confirming that each member of the group received at least one at least one of the tangible items. The message confirming that the one or more tangible items were received can be from each user or from a confirmation service from a shipping company or post office.

Server 110 then monitors the time interval within the time period of use. At one or more time intervals within the time period, server 110 sends a message to each member of the group directing them to send one or more tangible items they currently have to another member of the group. In various embodiments, and alternatively server 110 provides each member of the group with mailing labels and time intervals for shipment of tangible items at the beginning of the group transaction. In various embodiments, and alternatively server 110 provides selectable fields on the web site of server 110 that allow each member of the group to download mailing labels that can be used to ship a tangible item at the end of a time interval. Server 110 records no transaction fee in electronic database 120 for directing a member of a group to share a tangible item, for example.

The number of time intervals is preferably at least one less than the number of members in the group. When all members of the group have had the use of each tangible item that group members have in common, the group purchase transaction is completed. Server 110 records no transaction fee in electronic database 120 for directing a member of a group to share a tangible item, for example.

After the group purchase transaction, server 110 can record in electronic database 120 that the tangible items left in the possession of each group member belongs to that group member, for example. In various embodiments, after the group purchase transaction, server 110 can send a message to each member of the group requesting that they send the tangible item left in their possession as part of a swapping transaction.

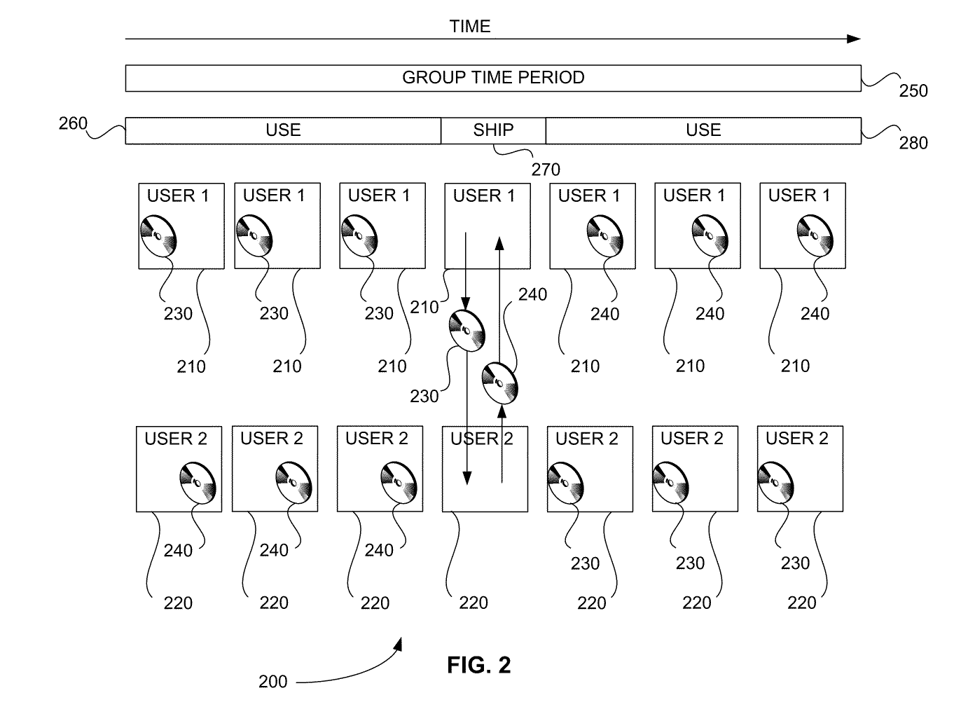

FIG. 2 is a time diagram 200 showing the sharing of tangible items in a group purchase transaction over time, in accordance with various embodiments. To start the group transaction, the wish lists or request lists of user 210 and user 220 are searched and found share tangible item 230 and tangible item 240 in common. User 210 and user 220 are offered and accept the opportunity to join a group for period of time 250. A seller of tangible items is notified to send tangible item 230 to user 210 and tangible item 240 to user 220. When confirmation is received that user 210 has received tangible item 230 and user 220 has received tangible item 240, time period 250 is begun.

The time within time period 250 is monitored. At time interval 260, user 210 is notified to send tangible item 230 to user 220 and user 220 is notified to send tangible item 240 to user 210. During shipping time 270 tangible item 230 is shipped to user 220, and tangible item 240 is shipped to user 210. After time interval 280, the group transaction is completed. Time intervals 260 and 280 are preferably substantially equivalent time periods. Time intervals 260 and 280 are shown as being three times as long as shipping time 270. Time intervals 260 and 280 can be longer or shorter than shipping time 270 depending on type of tangible items being shipped or the number of tangible items being shipped from each member of the group. In general, the cost effectiveness of a group purchase transaction increases as the number of members in the group increases. However, shipping costs increase significantly as the number of members increases. Also, shipping time 270 decreases the overall efficiency of a group purchase transaction.

Group Purchase Transaction with Overlapping Groups

In various embodiments, performing two or more group purchase transactions and staggering the time periods of the two or more group purchase transactions can eliminate shipping time 270 shown in FIG. 2. There is, however, a cost for eliminating shipping time 270. This cost is the need to purchase an additional set of tangible items.

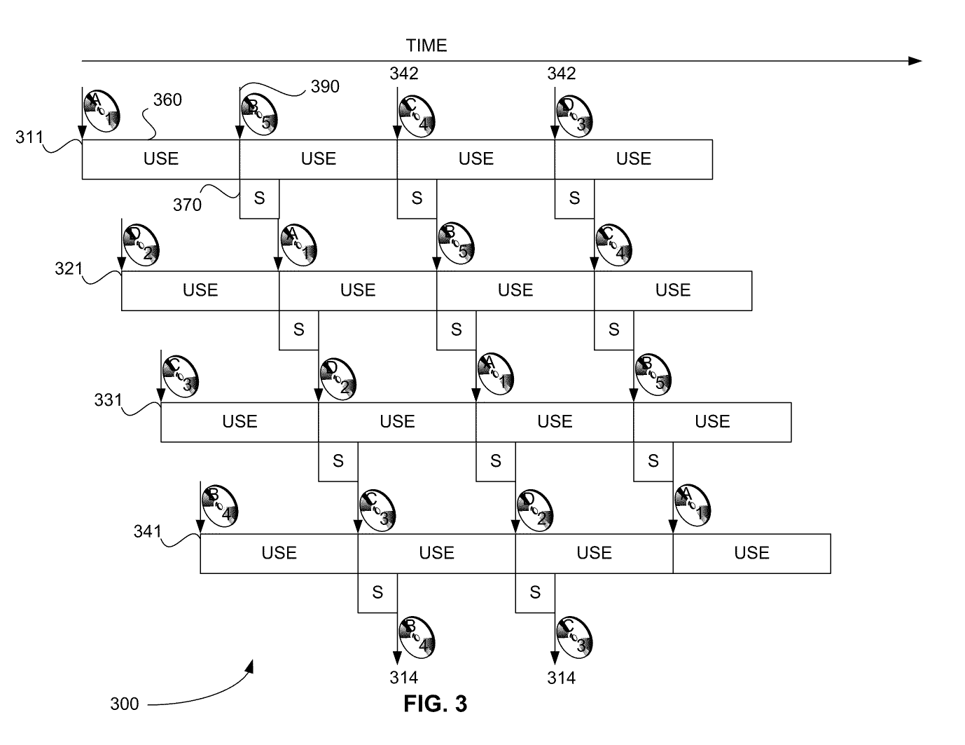

FIG. 3 is a time diagram 300 showing the sharing of tangible items among the first members, 311, 321, 331, and 341, of four overlapping groups participating in a group purchase transaction with overlapping groups over time, in accordance with various embodiments.

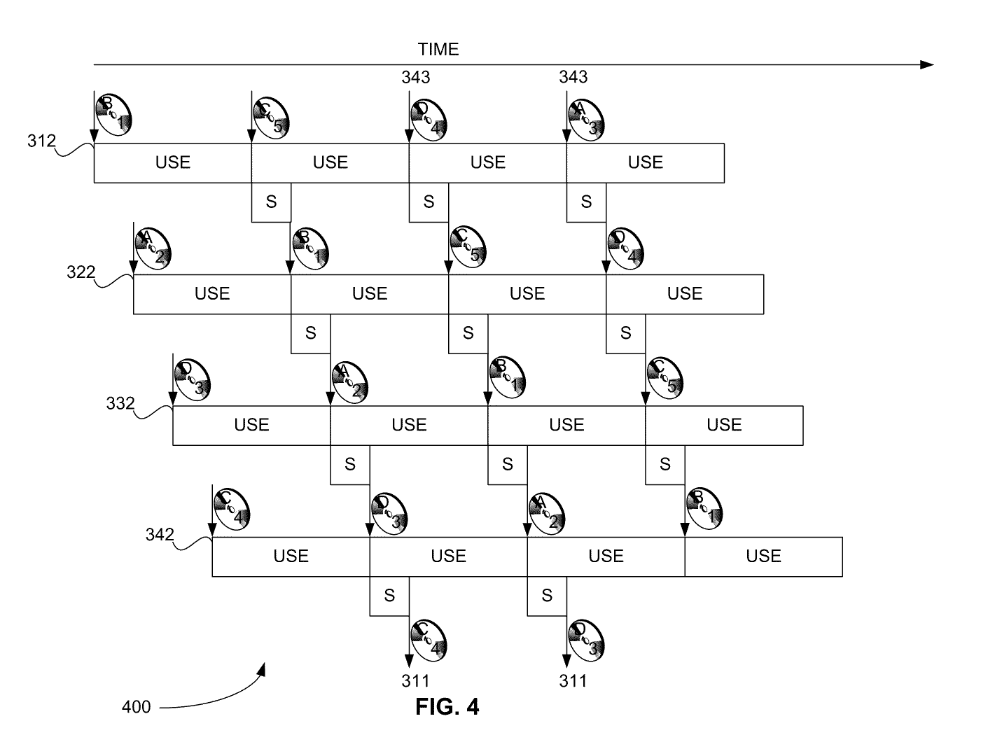

FIG. 4 is a time diagram 400 showing the sharing of tangible items among the second members, 312, 322, 332, and 342, of four overlapping groups participating in a group purchase transaction with overlapping groups over time, in accordance with various embodiments.

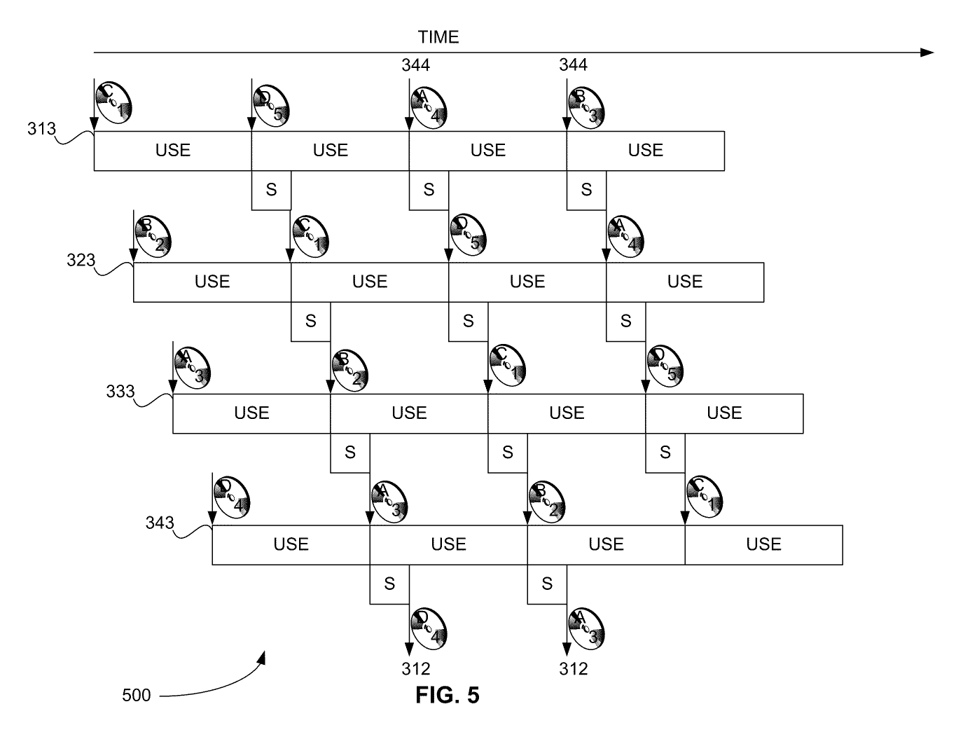

FIG. 5 is a time diagram 500 showing the sharing of tangible items among the third members, 313, 323, 333, and 343, of four overlapping groups participating in a group purchase transaction with overlapping groups over time, in accordance with various embodiments.

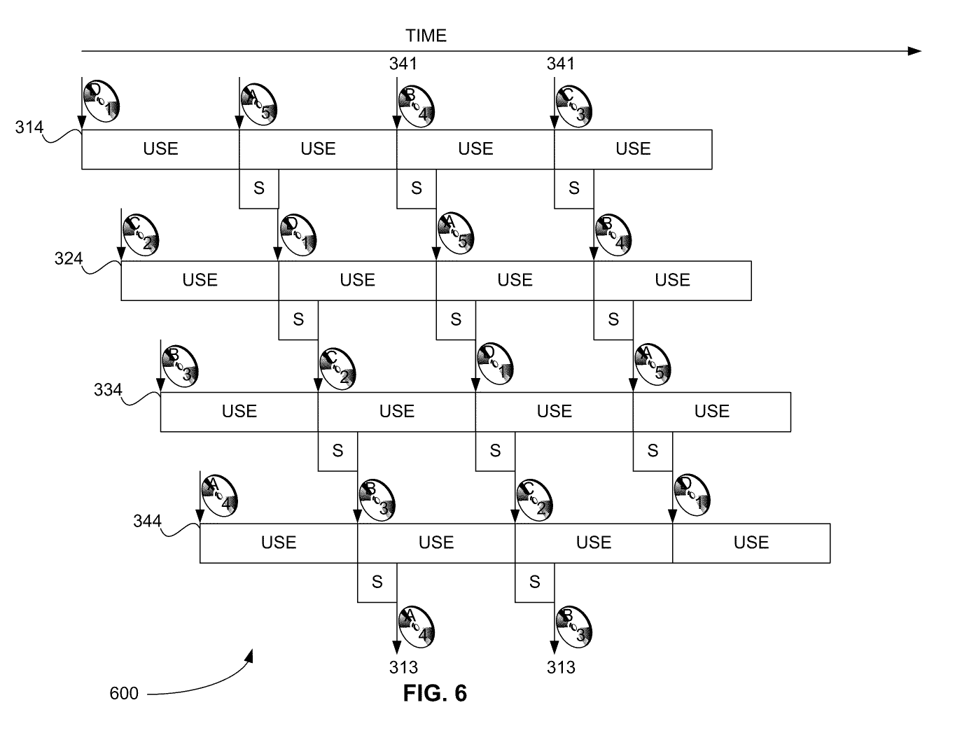

FIG. 6 is a time diagram 600 showing the sharing of tangible items among the fourth members, 314, 324, 334, and 344, of four overlapping groups participating in a group purchase transaction with overlapping groups over time, in accordance with various embodiments.

FIGS. 3-6 depict four overlapping groups where each group includes four members and each group purchases four tangible items. Also, each group purchases the same four tangible items.

A group purchase transaction with overlapping groups begins in the same fashion as a group purchase transaction. Wish lists or request lists are searched for members with tangible items in common. Once enough members are found to join a group, the members are offered to join the group. Once enough members accept and pay, a group is formed. Once enough groups are formed, tangible items are purchased for each group.

The number of groups needed for group purchase transaction with overlapping groups is determined by the amount of time a member is allowed to use a tangible item relative to the time needed to ship the tangible item. For example, as shown in FIG. 3, use time 360 is four times as long as shipping time 370. As a result, four overlapping groups are required to eliminate the shipping time. If the use time was three times as long as the ship time, then three overlapping groups would be required to eliminate the shipping time.

The amount of time by which overlapping groups are staggered is determined by the shipping time. For example, as shown in FIG. 3, member 321 of group two begins its transaction at an amount of time after member 311 of group one substantially equal to shipping time 370. This allows member 311 of group one to share its tangible items with member 321 of group two so that member 321 does not experience any time without a tangible item due to the shipping time. Similarly, member 331 of group three begins its transaction at an amount of time after member 321 of group two substantially equal to shipping time 370, and member 341 of group four begins its transaction at an amount of time after member 331 of group three substantially equal to shipping time 370.

Group four is now in a position to share tangible items with group one. For example, as shown in FIG. 3, member 341 of group four shares tangible items with member 314 (shown in FIG. 6) of group one.

FIGS. 3-6 show that in a group purchase transaction with overlapping groups, as in a group purchase transaction, tangible items are shared among members of a group. However, a group purchase transaction with overlapping groups differs from a group purchase transaction in that tangible items are shared between groups in a group purchase transaction with overlapping groups rather than within a group as in a group purchase transaction. Sharing items among groups allows the effects of the shipping time to be eliminated.

As mentioned above, eliminating the effects of the shipping time is not without cost. For example, as shown in FIG. 3, at time 390 member 311 of group one needs a tangible item. However, no other group is ready to provide a tangible item to member 311 without delay. Also, no other member of group one can provide a tangible item to member 311 without delay. As a result, in order to begin a group purchase transaction with overlapping groups an additional set of tangible items is needed to start the transaction. The number of items in the additional set of tangible items is equal to the number of tangible items purchased for one group. Note that as a percentage, the cost of the additional set of tangible items is reduced as the number of groups is increased.

The additional set of tangible items that is needed to start a group purchase transaction with overlapping groups can be purchased at the start of the transaction, for example. In various embodiments, the additional set of tangible items that is needed to start a group purchase transaction with overlapping groups can come from a previous group purchase transaction with overlapping groups that has ended.

The time period of use of each member of each group in the group purchase transaction with overlapping groups is monitored. Each member of each group is directed to send a tangible item to another member at a use interval.

When all members of every group have had the use of each tangible item the members share in common, the group purchase transaction with overlapping groups is completed. No transaction fees are recorded for directing a member of a group to share a tangible item, for example.

After the group purchase transaction with overlapping groups, the tangible items left in the possession of each group member belongs to that group member, for example. In various embodiments, after the group purchase transaction with overlapping groups, each group member can be requested to send the tangible item left in their possession as part of a swapping transaction. Note that because a group purchase transaction with overlapping groups requires an additional set of tangible items, these tangible items are also left in the possession of members of a group after the group purchase transaction with overlapping groups has completed.

In various embodiments, two or more tangible items are shared among members of different groups in a group purchase transaction with overlapping groups. Purchasing and shipping two or more tangible items has cost advantages.

### Bulk Shipping

In various embodiments, the transactional costs of swapping, purchasing, or renting tangible items can be reduced by using bulk shipping. Bulk shipping requires that a minimum number of tangible items be shipped at one time in order to reduce the cost of shipping per item. For example, the minimum number of books required for lowered shipping rates with some postal carriers is three.

In various embodiments, a user can request a minimum number of tangible items that corresponds to a bulk shipping rate, and a Web-based system can search the user's request list for the minimum number of tangible items. For example, the system can select the first three books listed by a requesting user in their request list. The system can then search for another user who has offered to exchange the same selected minimum number of tangible items. If another user is found, that user is asked to send the selected minimum number of tangible items to the requesting user. Once the requesting user has notified the system that the selected minimum number of tangible items is received, the exchange is complete.

Returning to FIG. 1, in various embodiments a system 100 for managing the exchange of tangible items using bulk shipping can include computer server 110, electronic database 120, and Internet connection 130. As described above, server 110 sends information to and receives information from a plurality of users using a plurality of clients 150 connected to the Internet 140.

Server 110 receives a request list for two or more tangible items from a first user through Internet connection 130. Server 110 receives a request for a bulk shipment of a minimum number of tangible items from the request list from the first user to begin a transaction through Internet connection 130. Server 110 searches the request list for minimum number of tangible items producing a selected list of tangible items. Server 110 searches electronic database 120 for a second user willing to exchange the selected list of tangible items. Server 110 sends a first message to the second user through Internet connection 130 requesting that the second user ship the selected list of tangible items to the first user. Finally, server 110 receives a second message from the first user through Internet connection 130 that the selected list of tangible items is received by the first user completing the transaction. In various embodiments, the transaction can include, but is not limited to, a swapping, purchasing, or renting transaction.

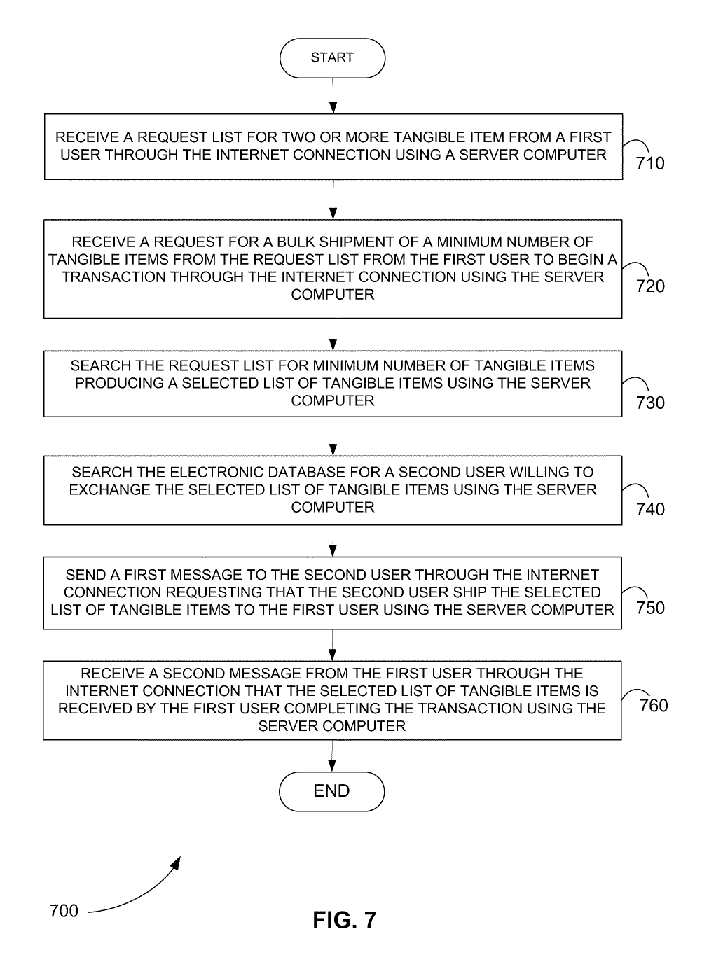

FIG. 7 is a flowchart showing a method 700 for managing the exchange of tangible items using bulk shipping and a request list, in accordance with various embodiments.

In step 710 of method 700, a request list for two or more tangible items is received from a first user through the Internet connection using a server computer.

In step 720, a request for a bulk shipment of a minimum number of tangible items from the request list is received from the first user to begin a transaction through the Internet connection using the server computer.

In step 730, the request list is searched for minimum number of tangible items producing a selected list of tangible items using the server computer.

In step 740, the electronic database is searched for a second user willing to exchange the selected list of tangible items using the server computer.

In step 750, a first message is sent to the second user through the Internet connection requesting that the second user ship the selected list of tangible items to the first user using the server computer.

In step 760, a second message is received from the first user through the Internet connection that the selected list of tangible items is received by the first user completing the transaction using the server computer.

In various embodiments, a computer program product includes a tangible computer-readable storage medium whose contents include a program with instructions being executed on a processor or server computer so as to perform a method for managing the exchange of tangible items using bulk shipping. This method is performed by a system of distinct software modules.

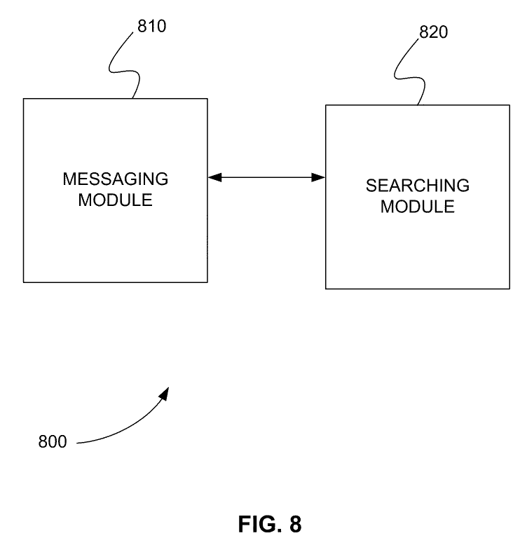

FIG. 8 is a schematic diagram of a system 800 of distinct software modules that performs a method for managing the exchange of tangible items using bulk shipping, in accordance with various embodiments. System 800 includes messaging module 810 and searching module 820. Messaging module 810 receives a request list for two or more tangible items from a first user through an Internet connection. Messaging module 810 receives a request for a bulk shipment of a minimum number of tangible items from the request list from the first user to begin a transaction through the Internet connection.

Searching module 820 searches the request list for minimum number of tangible items producing a selected list of tangible items. Searching module 820 searches an electronic database for a second user willing to exchange the selected list of tangible items.

Messaging module 810 sends a first message to the second user through the Internet connection requesting that the second user ship the selected list of tangible items to the first user. Finally, messaging module 810 receives a second message from the first user through the Internet connection that the selected list of tangible items is received by the first user completing the transaction.

In various embodiments, a user can request a minimum number of tangible items that corresponds to a bulk shipping rate, and a Web-based system can determine the tangible items available for exchange. For example, the system can search for all the users who have listed the minimum number of tangible items and create a list of available tangible items. The system can then receive selections from the user one at a time that reduce the list of available tangible items after each selection. For example, after a requesting user selects a book from the list, a new search is conducted for all users who offered to ship the selected book and at least the minimum number of tangible items minus one. All the tangible items from these users are then used to recreate the list from which the user can make a second selection. Once the number of selections made by the user is equivalent to the minimum number of tangible items, a user who has listed all of the selected tangible items is identified and asked to send the selected tangible items to the requesting user. Once the requesting user has notified the system that the selected minimum number of tangible items is received, the exchange is complete.

Again returning to FIG. 1, in various embodiments a system 100 for managing the exchange of tangible items using bulk shipping can include computer server 110, electronic database 120, and Internet connection 130.

Server 110 receives a request for a bulk shipment of a minimum number of tangible items from a first user to begin a transaction through Internet connection 130. Server 110 searches electronic database 120 for users who have offered to exchange the minimum number of tangible items and creates a list of tangible items found. Server 110 presents the list to the first user through Internet connection 130. Server 110 receives a selection from the list from the first user through Internet connection 130 and stores the selection in electronic database 120. If the number of stored selections is not equal to the minimum number of tangible items, server 110 searches the list for a group of users who have offered to exchange the selection, creates a new list of tangible items found, uses the new list as the list, and repeats the steps of presenting the list, receiving a selection, and comparing the number of stored selections to the minimum number of tangible items. If the number of stored selections is equal to the minimum number of tangible items, server 110 selects a second user from the group, sends a first message to the second user through Internet connection 130 requesting that the second user ship the stored selections to the first user, and receives a second message from the first user through Internet connection 130 that the stored selections are received by the first user completing the transaction.

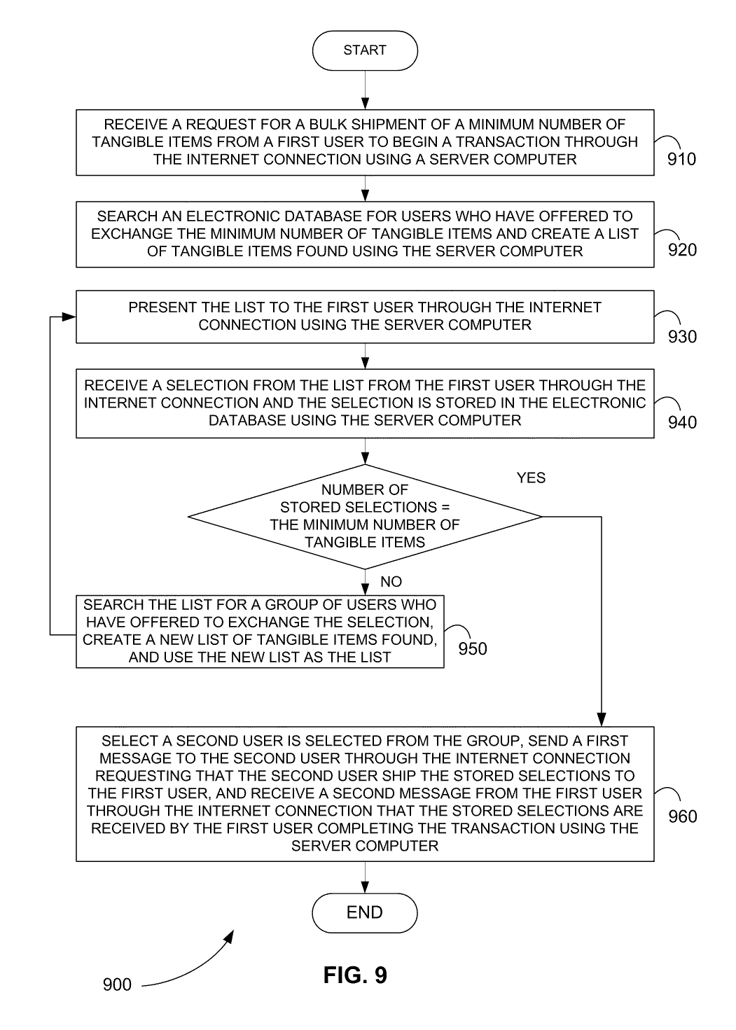

FIG. 9 is a flowchart showing a method 900 for managing the exchange of tangible items using bulk shipping, in accordance with various embodiments.

In step 910 of method 900, a request for a bulk shipment of a minimum number of tangible items is received from a first user to begin a transaction through the Internet connection using a server computer.

In step 920, an electronic database is searched for users who have offered to exchange the minimum number of tangible items and a list of tangible items found is created using the server computer.

In step 930, the list is presented to the first user through the Internet connection using the server computer.

In step 940, a selection from the list is received from the first user through the Internet connection and the selection is stored in the electronic database using the server computer.

In step 950, if a number of stored selections is not equal to the minimum number of tangible items, the list is searched for a group of users who have offered to exchange the selection, a new list of tangible items found is created, the new list is used as the list, and steps 930-950 are repeated using the server computer.

In step 960, if a number of stored selections is equal to the minimum number of tangible items, a second user is selected from the group, a first message is sent to the second user through the Internet connection requesting that the second user ship the stored selections to the first user, and a second message is received from the first user through the Internet connection that the stored selections are received by the first user completing the transaction using the server computer.

Returning to FIG. 8, in various embodiments a system 800 of distinct software modules performs a method for managing the exchange of tangible items using bulk shipping. Messaging module 810 receives a request for a bulk shipment of a minimum number of tangible items from a first user to begin a transaction through an Internet connection. Searching module 820 searches an electronic database for users who have offered to exchange the minimum number of tangible items and creates a list of tangible items found.

Messaging module 810 presents the list to the first user through the Internet connection. Messaging module 810 receives a selection from the list from the first user through the Internet connection and stores the selection in the electronic database. If the number of stored selections is not equal to the minimum number of tangible items, system 800 searches the list for a group of users who have offered to exchange the selection, creates a new list of tangible items found, uses the new list as the list, and repeats the steps of presenting the list, receiving a selection, and comparing the number of stored selections to the minimum number of tangible items. If the number of stored selections is equal to the minimum number of tangible items, searching module 820 selects a second user from the group, message module 810 sends a first message to the second user through the Internet connection requesting that the second user ship the stored selections to the first user, and message module 810 receives a second message from the first user through the Internet connection that the stored selections are received by the first user completing the transaction.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for managing the exchange of tangible items, comprising:
an Internet connection;
an electronic database; and
a server computer that is connected to the electronic database, and communicates with users through the Internet connection, wherein the server
receives a request list for two or more tangible items from a first user through the Internet connection,
receives a request for a bulk shipment of a minimum number of tangible items from the request list from the first user to begin a transaction through the Internet connection,
searches the request list for minimum number of tangible items producing a selected list of tangible items,
searches the electronic database for a second user willing to exchange the selected list of tangible items,
sends a first message to the second user through the Internet connection requesting that the second user ship the selected list of tangible items to the first user, and
receives a second message from the first user through the Internet connection that the selected list of tangible items is received by the first user completing the transaction.

2. The system of claim 1, wherein transaction comprises a swapping transaction.

3. The system of claim 1, wherein transaction comprises a purchase transaction.

4. The system of claim 1, wherein transaction comprises a renting transaction.

5. The system of claim 1, wherein the two or more tangible items comprise books.

6. The system of claim 1, wherein the two or more tangible items comprise compact discs (CDs).

7. The system of claim 1, wherein the two or more tangible items comprise digital video discs (DVDs).

8. The system of claim 1, wherein the two or more tangible items comprise digital video discs (DVDs).

9. The system of claim 1, wherein the two or more tangible items comprise flash memory.

10. A method for managing the exchange of tangible items, comprising:
receiving a request list for two or more tangible items from a first user through the Internet connection using a server computer;
receiving a request for a bulk shipment of a minimum number of tangible items from the request list from the first user to begin a transaction through the Internet connection using the server computer;
searching the request list for minimum number of tangible items producing a selected list of tangible items using the server computer;
searching the electronic database for a second user willing to exchange the selected list of tangible items using the server computer;
sending a message to the second user through the Internet connection requesting that the second user ship the selected list of tangible items to the first user using the server computer; and
receiving a message from the first user through the Internet connection that the selected list of tangible items is received by the first user completing the transaction using the server computer.

11. A system for managing the exchange of tangible items, comprising:
an Internet connection;
an electronic database; and
a server computer that is connected to the electronic database, and communicates with users through the Internet connection, wherein the server
(a) receives a request for a bulk shipment of a minimum number of tangible items from a first user to begin a transaction through the Internet connection,
(b) searches the electronic database for users who have offered to exchange the minimum number of tangible items and creates a list of tangible items found,
(c) presents the list to the first user through the Internet connection,
(d) receives a selection from the list from the first user through the Internet connection and stores the selection in the electronic database,
(e) if a number of stored selections is not equal to the minimum number of tangible items, searches the list for a group of users who have offered to exchange the selection, creates a new list of tangible items found, uses the new list as the list, and repeats steps (c)-(e), and
(f) if a number of stored selections is equal to the minimum number of tangible items, selects a second user from the group, sends a first message to the second user through the Internet connection requesting that the second user ship the stored selections to the first user, and receives a second message from the first user through the Internet connection that the stored selections are received by the first user completing the transaction.

12. The system of claim 11, wherein transaction comprises a swapping transaction.

13. The system of claim 11, wherein transaction comprises a purchase transaction.

14. The system of claim 11, wherein transaction comprises a renting transaction.

15. The system of claim 11, wherein the two or more tangible items comprise books.

16. The system of claim 11, wherein the two or more tangible items comprise compact discs (CDs).

17. The system of claim 11, wherein the two or more tangible items comprise digital video discs (DVDs).

18. The system of claim 11, wherein the two or more tangible items comprise digital video discs (DVDs).

19. The system of claim 11, wherein the two or more tangible items comprise flash memory.

20. A method for managing the exchange of tangible items, comprising:
(a) receiving a request for a bulk shipment of a minimum number of tangible items from a first user to begin a transaction through the Internet connection using a server computer;
(b) searching an electronic database for users who have offered to exchange the minimum number of tangible items and creating a list of tangible items found using the server computer;
(c) presenting the list to the first user through the Internet connection using the server computer;
(d) receiving a selection from the list from the first user through the Internet connection and storing the selection in the electronic database using the server computer;
(e) if a number of stored selections is not equal to the minimum number of tangible items, searching the list for a group of users who have offered to exchange the selection, creating a new list of tangible items found, using the new list as the list, and repeating steps (c)-(e) using the server computer; and
(f) if a number of stored selections is equal to the minimum number of tangible items, selecting a second user from the group, sending a first message to the second user through the Internet connection requesting that the second user ship the stored selections to the first user, and receiving a second message from the first user through the Internet connection that the stored selections are received by the first user completing the transaction using the server computer.
